(19) United States
(12) Patent Application Publication
(10) Pub. No.: US 2012/0200927 A1
(43) Pub. Date: Aug. 9, 2012

(54) OPTICAL ELEMENT HAVING ANTI-REFLECTION FILM

(75) Inventors: Takeshi Deguchi, Tokyo (JP); Masanori Koyama, Tokyo (JP); Ryo Sakurai, Kamiina-gun (JP); Nobuyoshi Toyohara, Sagamihara-shi (JP)

(73) Assignee: Olympus Corporation, Tokyo (JP)

(21) Appl. No.: 13/364,686

(22) Filed: Feb. 2, 2012

(30) Foreign Application Priority Data
Feb. 7, 2011 (JP) 2011-024223

(51) Int. Cl. G02B 1/10

(52) U.S. Cl. 359/580

(57) ABSTRACT

An optical element having anti-reflection film includes an anti-reflection film having a reflection characteristic expressed by a function Fm(x), which is on an m^{th} optical surface, and an anti-reflection film having a reflection characteristic expressed by a function Fn(x), which is on an n^{th} optical surface. At least one of the Fm(x) and Fn(x) functions has the maximum value of reflectance in a predetermined wavelength, and has a characteristic curve of W-shape, and the other of the Fm(x) and Fn(x) function has a wavelength that negates at least one maximum value of the Fm(x) and the Fn(x) functions. The anti-reflection film having reflection characteristic expressed by the function Fm(x) is on an optical surface on a side nearer to the light source, than the anti-reflection film having reflectance characteristic expressed by the function Fn(x), where, m and n are positive integers, and m<n.

### CROSS-REFERENCE TO RELATED APPLICATION

The present application is based upon and claims the benefit of priority from the prior Japanese Patent Application No. 2011-024223 filed on Feb. 7, 2011; the entire contents of which are incorporated herein by reference.

### BACKGROUND OF THE INVENTION

1. Field of the Invention

The present invention relates to an optical element having anti-reflection film.

2. Description of the Related Art

In an optical element such as a lens or a prism used in a camera, a microscope, an endoscope, and binoculars, for suppressing surface reflection and improving a transmittance of light of the optical element, an anti-reflection film is formed on a surface of the optical element.

A number of basic structures have been known for the anti-reflection film. For instance, on page 127 of ‘Optical thin film’ written by H. A. Maclaod, translated by Ogura Shigetaro et al., published by ‘NIKKAN KOGYO SHINBUN LTD. (BUSINESS & TECHNOLOGY DAILY NEWS)’, the following film structure has been described. A film structure of a glass substrate (refractive index n=1.52), a first layer (refractive index n=1.90, optical film thickness 1.00), a second layer (refractive index n=2.00, optical film thickness 1.00), a third layer (refractive index n=1.38, optical film thickness 1.00), and air, when an optical film thickness λ0/4 at a reference wavelength λ0 (unit: nm) is let to be λ0/4=1.00, has been described.

The authors have indicated a result when a reflectance characteristic was calculated letting the reference wavelength λ0=530 nm as the anti-reflection film of a visible range from this film structure. A curve of the reflectance characteristic has a W-shaped waveform when a horizontal axis is let to be wavelength (unit: nm) and a vertical axis is let to be reflectance (unit: %). Therefore, it is called as a W-coat. Moreover, in Japanese Patent Application Laid-open Publication No. Sho 52-76942, from a point of view of productivity, a W-coat having a five-layered structure or a seven-layered structure in which a film material having refractive indices of two types namely high refractive index and low refractive index are used.

In an optical element such as a lens and a prism, it is desirable that a ghost image and a flare are reduced as much as possible. This is because when there is a ghost image or a flare on a screen or in a field of view, an image quality is degraded or an observation of an object is hindered. A ghost image and a flare occur due to light being reflected for a plurality of times (for example, internal reflection) between a front lens surface and a rear lens surface, or between lenses.

Even when an anti-reflection film is formed on a specific optical surface, due to the abovementioned W-shaped characteristic curve, it is difficult to reduce the reflectance characteristic uniformly in all ranges of a desired wavelength range. Accordingly, at the optical surface on which the anti-reflection film is formed, light of a wavelength for which an intensity of light cannot be reduced fully, is reflected at a certain optical surface (first reflecting surface), and is incident on another optical surface (second reflecting surface). Furthermore, by light which has been reflected from the second reflecting surface, forming an image on an image forming surface, or being incident on an image pickup element, there is a ghost image or a flare.

### SUMMARY OF THE INVENTION

An optical element having anti-reflection film according to the present invention is an optical element which is used in an optical system for guiding light generated from a light source, to an image pickup element or an image forming surface, includes

an anti-reflection film having a reflectance characteristic expressed by a function Fm(x) (where, x denotes a wavelength), which is formed on an m^{th} optical surface when counted from a side of the light source, and

an anti-reflection film having a reflectance characteristic expressed by a function Fn(x) (where, x denotes a wavelength), which is formed on an n^{th} optical surface when counted from the side of the light source, and

at least one of the function Fm(x) and the function Fn(x) has the maximum value of reflectance in a predetermined wavelength, and has a characteristic curve of W-shape, and

the other of the function Fm(x) and the function Fn(x) has a wavelength that negates at least one maximum value of one of the function Fm(x) and the function Fn(x), and

the anti-reflection film having reflectance characteristic expressed by the function Fm(x) is formed on an optical surface on a side nearer to the light source, than the anti-reflection film having reflectance characteristic expressed by the function Fn(x),

where, m and n are positive integers, and m<n.

### BRIEF DESCRIPTION OF THE DRAWINGS

FIG. 1 is a diagram showing reflectance characteristic described in non-patent literature 1 (page 127 of ‘Optical thin film’ written by H. A. Maclaod, translated by Ogura Shigetaro at al., Published by ‘NIKKAN KOGYO SHINBUN LTD. (BUSINESS & TECHNOLOGY DAILY NEWS)’);

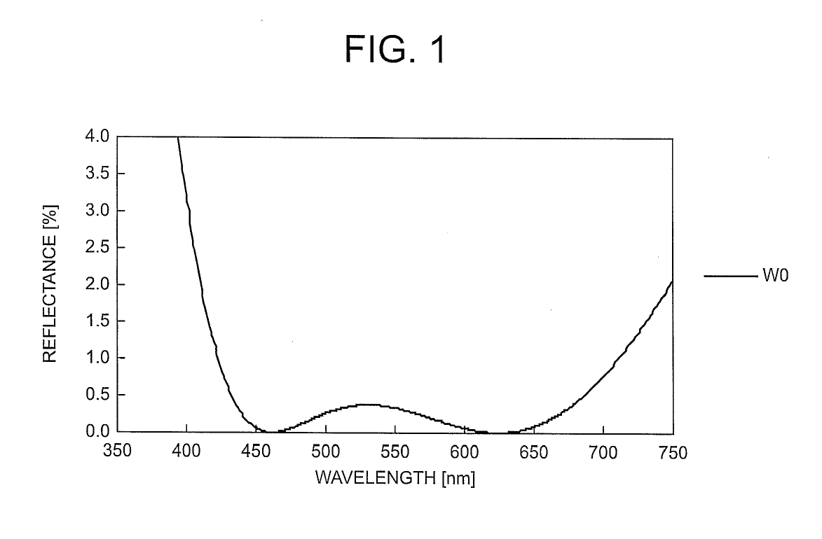

FIG. 2 is a diagram showing reflectance characteristic of sample 1 of an anti-reflection film Ln formed on an n^{th} surface, when an angle of incidence with respect to the anti-reflection film is 0° and 30°;

FIG. 3 is a diagram showing reflectance characteristic of sample 2 of the anti-reflection film Ln formed on the n^{th} surface, when the angle of incidence with respect to the anti-reflection film is 0° and 30°;

FIG. 4 is a diagram showing reflectance characteristic according to a first example of an anti-reflection film Lm formed on an m^{th} surface, when an angle of incidence with respect to the anti-reflection film is 0°, 30°, and 45°;

FIG. 5 is a diagram showing reflectance characteristic according to a second example of an anti-reflection film Lm formed on an m^{th} surface, when an angle of incidence with respect to the anti-reflection film is 0°, 30°, and 45°;

FIG. 6 is a diagram showing reflectance characteristic according to a third example of an anti-reflection film Lm formed on an m^{th} surface, when an angle of incidence with respect to the anti-reflection film is 0°, 30°, and 45°;

FIG. 7 is a diagram showing reflection characteristic according to a fourth example of an anti-reflection film Lm formed on an m^{th} surface, when an angle of incidence with respect to the anti-reflection film is 0°, 30°, and 45°;

FIG. 8 is a diagram showing reflectance characteristic according to a fifth example of an anti-reflection film Lm formed on an m^{th} surface, when an angle of incidence with respect to the anti-reflection film is 0°, 30°, and 45°;

FIG. 9 is a diagram showing reflectance characteristic according to a sixth example of an anti-reflection film Lm formed on an m^{th} surface, when an angle of incidence with respect to the anti-reflection film is 0°, 30°, and 45°;

FIG. 10 is a diagram showing reflectance characteristic according to a seventh example of an anti-reflection film Lm formed on an m^{th} surface, when an angle of incidence with respect to the anti-reflection film is 0°, 30°, and 45°;

FIG. 11 is a diagram showing an average value of reflectance characteristic of a structure W1 formed on an n^{th} optical surface and a structure H1 formed on an m^{th} optical surface, and of a structure W2 formed on the n^{th} optical surface and a structure H2 formed on the m^{th} optical surface, at an angle of incidence=0°;

FIG. 12 is a diagram showing an average value of reflectance characteristic of the structure W1 formed on the n^{th} optical surface and a structure H3 formed on the m^{th} optical surface, and a structure W2 formed on the n^{th} optical surface and the structure H4 formed on the m^{th} optical surface, at the angle of incidence=0°;

FIG. 13 is a diagram showing an average value of reflectance characteristic of the structure W1 formed on the n^{th} optical surface and a structure H5 formed on the m^{th} optical surface, the structure W2 formed on the n^{th} optical surface and a structure H6 formed on the m^{th} optical surface, and the structure W2 formed on the n^{th} optical surface and a structure H7 formed on the m^{th} optical surface, at the angle of incidence=0°

FIG. 14 is a diagram showing a result of adding three types of reflectance characteristic (W1, W2 and combination of W1 and W2) in a case in which, two types of anti-reflection films having the structures W1 and W2 respectively formed on the n^{th} optical surface, are formed on the m^{th} optical surface, at the angle of incidence=0°;

FIG. 15 is a diagram showing a result of adding three types of reflectance characteristic (W1, W2 and combination of W1 and W2) in a case in which, two types of anti-reflection films having the structures W1 and W2 respectively formed on the n^{th} optical surface, are formed on the m^{th} optical surface, at the angle of incidence=30°;

FIG. 16 is a diagram showing an average value of reflectance characteristic of the structure W1 formed on the n^{th} optical surface and the structure H1 formed on the m^{th} optical surface, and of the structure W2 formed on the n^{th} optical surface and the structure H2 formed on the m^{th} optical surface, at an angle of incidence=30°;

FIG. 17 is a diagram showing an average value of reflectance characteristic of the structure W1 formed on the n^{th} optical surface and the structure H3 formed on the m^{th} optical surface, and the structure W2 formed on the n^{th} optical surface and the structure H4 formed on the m^{th} optical surface, at an angle of incidence=30°;

FIG. 18 is a diagram showing an average value of reflectance characteristic of the structure W1 formed on the n^{th} optical surface and the structure H5 formed on the m^{th} optical surface, the structure W2 formed on the n^{th} optical surface and the structure H6 formed on the m^{th} optical surface, and the structure W2 formed on the n^{th} optical surface and the structure H7 formed on the m^{th} optical surface, at an angle of incidence=30°; and

FIG. 19 is a diagram showing a schematic structure of an optical system 10 which includes an optical element having anti-reflection film.

### DETAILED DESCRIPTION OF THE INVENTION

Examples of an optical element having anti-reflection film according to the present invention will be described below in detail by referring to the accompanying diagrams. However, the present invention is not restricted to the examples described below.

In these examples, cases in which, lenses of glass materials having three types of refractive indices, and anti-reflection films corresponding to the refractive indices of the glass material are combined will be described. However, the present invention is not restricted to the following examples. Moreover, refractive indices are not restricted to the refractive indices of the glass materials described in these examples.

A method of forming an anti-reflection film on a lens or a prism may be any of a vacuum vapor deposition method, a sputtering method, an ion assist film-forming method, a chemical vapor deposition method, a spin coat method, and a dipping method.

Moreover, an optical film thickness of a film structure of these examples is a value when λ0/4 at a reference wavelength (unit: nm) is let to be λ0/4=1.00.

The optical element having anti-reflection film according to an embodiment will be described below.

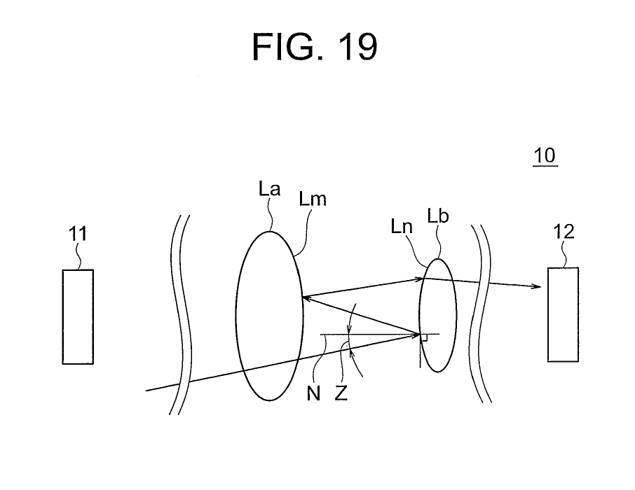

FIG. 19 is a diagram showing a schematic structure of an optical system 10 which includes the optical element having anti-reflection film. Lenses La and Lb are disposed in order from a side of a light source 11. In the optical system 10 for forming an image of an object which is not shown in the diagram, on an image pickup element 12, lenses other than the lens La and lens Lb are not shown in the diagram.

The optical system 10 is used for guiding light from the light source 11 to the image pickup element 12. The lens La and the lens Lb are optical elements in the optical system 10.

An anti-reflection film Lm having reflectance characteristic expressed by a function Fn(x) (where, x denotes a wavelength), is formed on an m^{th} optical surface, when counted from the side of the light source 11.

Moreover, an anti-reflection film Ln having reflectance characteristic expressed by a function Fn(x) (where, x denotes the wavelength), is formed on an n^{th} optical surface, when counted from the side of the light source 11.

Here, m and n are positive integers, and m<n.

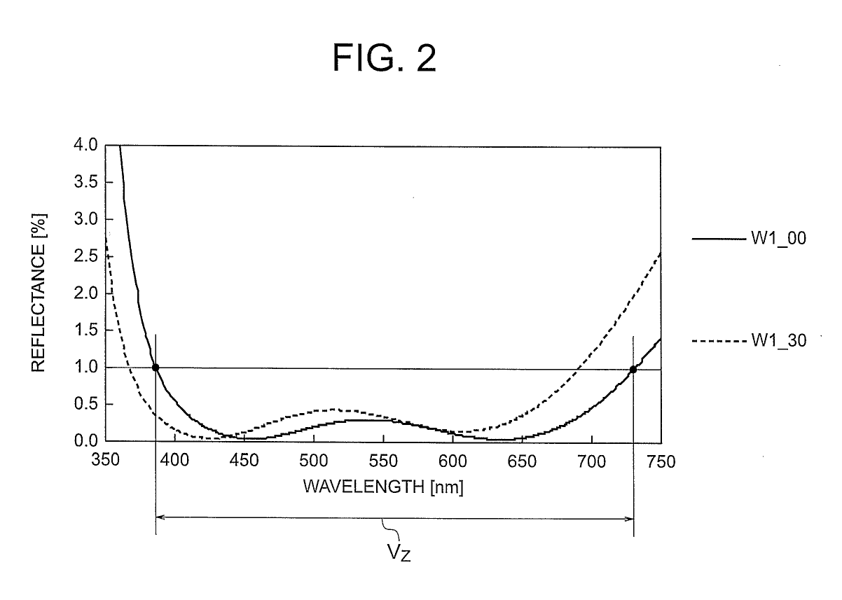

FIG. 2 is a diagram showing reflectance characteristic (W1_00, W1_30) of the anti-reflection film Ln formed on the n^{th} optical surface when an angle of incidence z with respect to an anti-reflection film W1 is z=0° and 30°. The reflectance characteristic will be described below by using a graph in which a horizontal axis is let to be a wavelength (unit: nm) and a vertical axis is let to be a reflectance (unit: %).

Here, an angle of incidence is an angle z (unit: degree) between a normal N of an incidence surface and a light of incidence as shown in FIG. 19.

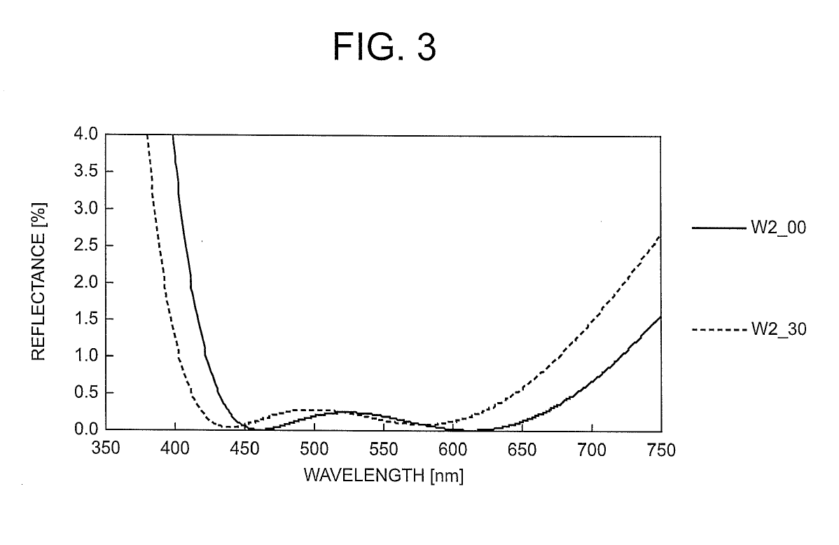

FIG. 3 is a diagram showing reflectance characteristic (W2_00, W2_30) of the anti-reflection film Ln formed on the n^{th} optical surface when the angle of incidence z with respect to an anti-reflection film W2 is z=0° and 30°.

In FIG. 2 and FIG. 3, reflectance characteristic for each of the two types of anti-reflection films W1 and W2 is shown.

A curve which indicates the reflectance characteristic is let to be a function Fn(x). The function Fn(x), as it is clear from FIG. 2 and FIG. 3, has the maximum value of the reflectance at a predetermined wavelength, and has a W-shaped characteristic.

TABLE 1
Film structure of W1 and W2
Film structure of W1
Reference wavelength λ0: 520 nm
(1) Layer number
(2) Material,
(3) Refractive index,
(4) Optical film thickness,
(5) Physical film thickness (nm)

| (1) | (2) | (3) | (4) | (5) |
|---|---|---|---|---|
| Substrate | BK7 | 1.52 | | |
| The 1st layer | MGF₂ | 1.38 | 0.360 | 34 |
| The 2nd layer | ZrO₂ | 2.10 | 0.276 | 17 |
| The 3rd layer | MGF₂ | 1.38 | 0.424 | 40 |
| The 4th layer | ZrO₂ | 2.10 | 0.792 | 49 |
| The 5th layer | MGF₂ | 1.38 | 0.208 | 20 |
| The 6th layer | ZrO₂ | 2.10 | 0.668 | 41 |
| The 7th layer | MGF₂ | 1.38 | 1.068 | 101 |

Film structure of W2
Reference wavelength λ0: 520 nm

| (1) | (2) | (3) | (4) | (5) |
|---|---|---|---|---|
| Substrate | TIH1 | 1.72 | | |
| The 1st layer | MGF₂ | 1.38 | 0.138 | 13 |
| The 2nd layer | ZrO₂ | 2.10 | 0.743 | 46 |
| The 3rd layer | MGF₂ | 1.38 | 0.244 | 23 |
| The 4th layer | ZrO₂ | 2.10 | 0.743 | 46 |
| The 5th layer | MGF₂ | 1.38 | 1.136 | 107 |

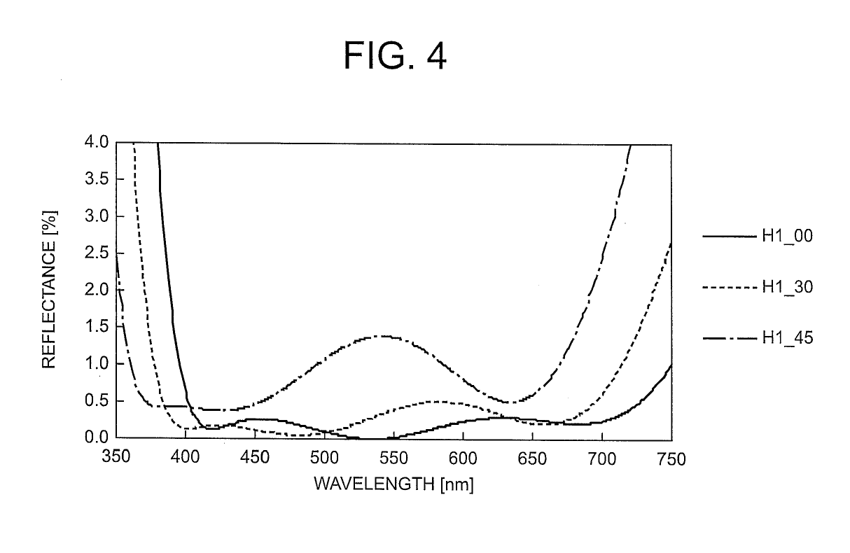

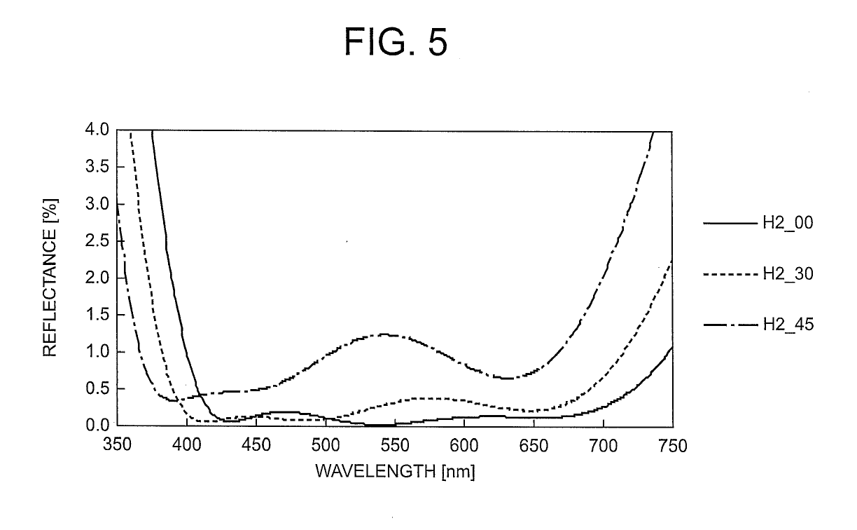

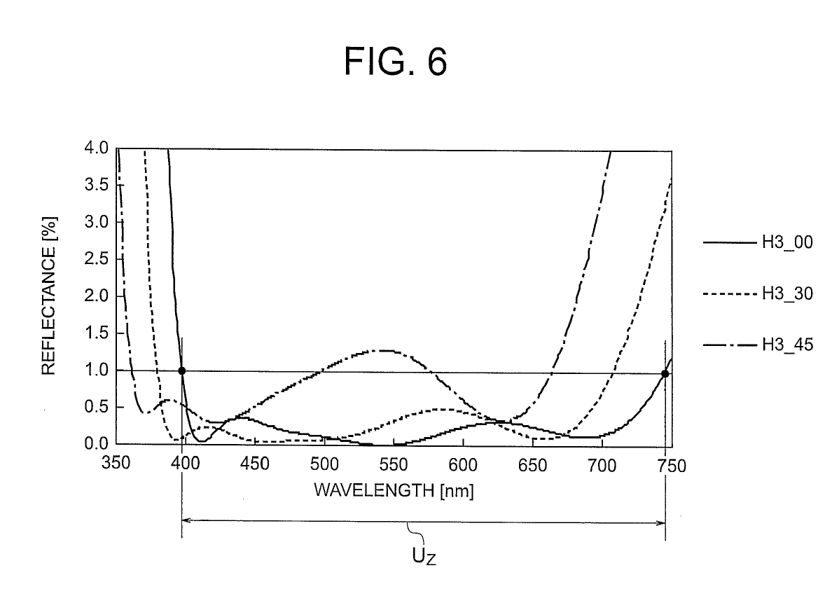

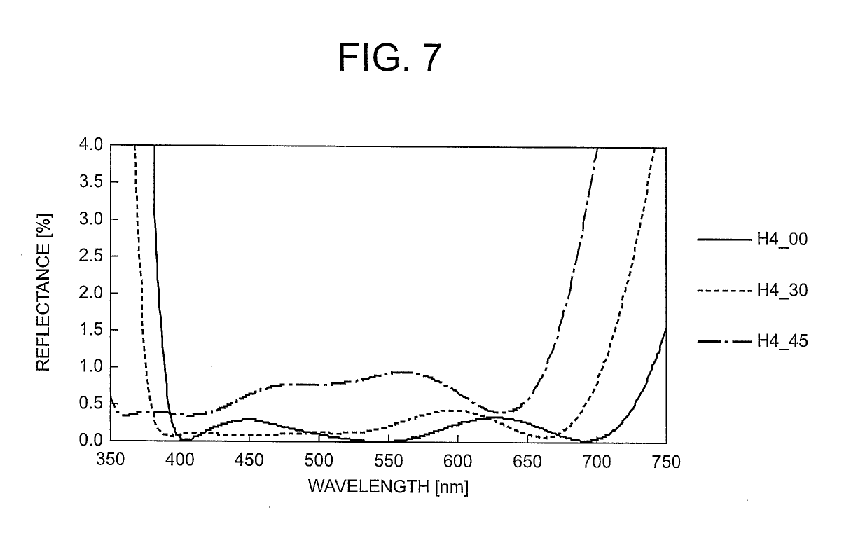

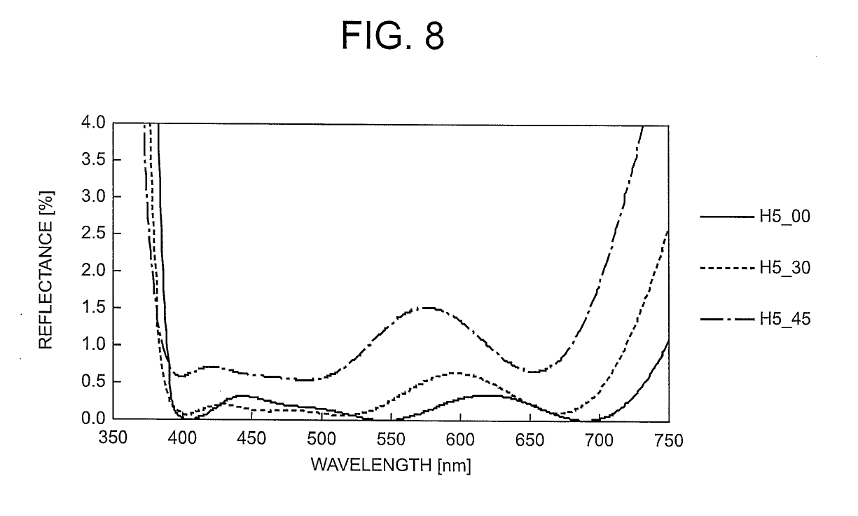

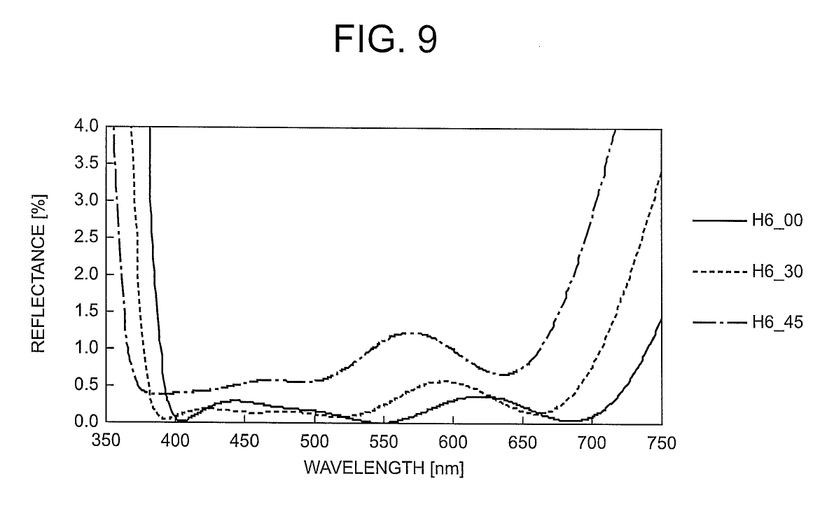

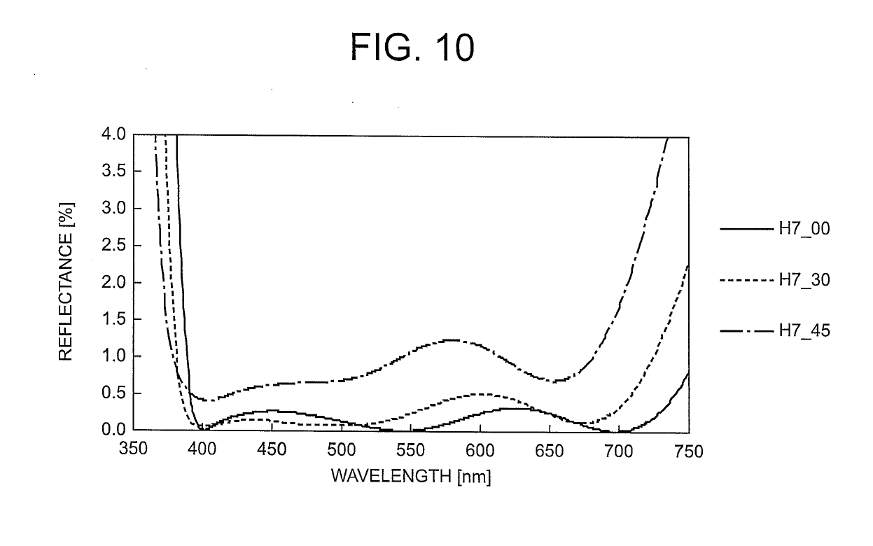

FIG. 4, FIG. 5, FIG. 6, FIG. 7, FIG. 8, FIG. 9, and FIG. 10 are diagrams showing reflectance characteristic of the anti-reflection film Lm formed on the M^{th} surface when the angle of incidence with respect to the anti-reflection film is 0°, 30°, and 45°.

FIG. 4 shows reflectance characteristic H1_00, H1_30, and H1_45 for an anti-reflection film H1 when the angle of incidence z with respect to the anti-reflection film is z=0°, 30°, and 45°.

FIG. 5 shows reflectance characteristic H2_00, H2_30, and H2_45 for an anti-reflection film H2 when the angle of incidence z with respect to the anti-reflection film is z=0°, 30°, and 45°.

FIG. 6 shows reflectance characteristic H3_00, H3_30, and H3_45 for an anti-reflection film H3 when the angle of incidence z with respect to the anti-reflection film is z=0°, 30°, and 45°;

FIG. 7 shows reflectance characteristic H4_00, H4_30, and H4_45 for an anti-reflection film H4 when the angle of incidence z with respect to the anti-reflection film is z=0°, 30°, and 45°.

FIG. 8 shows reflectance characteristic H5_00, H5_30, and H5_45 for an anti-reflection film H5 when the angle of incidence z with respect to the anti-reflection film is z=0°, 30°, and 45°.

FIG. 9 shows reflectance characteristic H6_00, H6_30, and H6_45 for an anti-reflection film H6 when the angle of incidence z with respect to the anti-reflection film is z=0°, 30°, and 45°.

FIG. 10 shows reflectance characteristic H7_00, H7_30, and H7_45 for an anti-reflection film H7 when the angle of incidence z with respect to the anti-reflection film is z=0°, 30°, and 45°.

Structures of seven types of examples from the anti-reflection film H1 to the anti-reflection film H7 are indicated below in tables from table 2 to table 8 respectively.

TABLE 2
First example
Structure of H1:
Reference wavelength λ0: 500 nm

| (1) | (2) | (3) | (4) | (5) |
|---|---|---|---|---|
| Substrate | LAH60 | 1.85 | | |
| The 1st layer | MgF₂ | 1.38 | 0.244 | 22 |
| The 2nd layer | ZrO₂ | 2.07 | 0.308 | 19 |
| The 3rd layer | MgF₂ | 1.38 | 2.161 | 196 |
| The 4th layer | ZrO₂ | 2.07 | 0.272 | 16 |
| The 5th layer | MgF₂ | 1.38 | 0.192 | 17 |
| The 6th layer | ZrO₂ | 2.07 | 1.762 | 106 |
| The 7th layer | MgF₂ | 1.38 | 1.005 | 91 |

TABLE 3
Second example
Structure of H2:
Reference wavelength λ0: 500 nm

| (1) | (2) | (3) | (4) | (5) |
|---|---|---|---|---|
| Substrate | BK7 | 1.53 | | |
| The 1st layer | MgF₂ | 1.38 | 0.268 | 24 |
| The 2nd layer | ZrO₂ | 2.07 | 0.106 | 6 |
| The 3rd layer | MgF₂ | 1.38 | 2.077 | 188 |
| The 4th layer | ZrO₂ | 2.07 | 0.202 | 12 |
| The 5th layer | MgF₂ | 1.38 | 0.345 | 31 |
| The 6th layer | ZrO₂ | 2.07 | 2.024 | 122 |
| The 7th layer | MgF₂ | 1.38 | 1.018 | 92 |

TABLE 4
Third example
Structure of H3:
Reference wavelength λ0: 500 nm

| (1) | (2) | (3) | (4) | (5) |
|---|---|---|---|---|
| Substrate | LAH60 | 1.85 | | |
| The 1st layer | ZrO₂ | 2.07 | 0.541 | 33 |
| The 2nd layer | MgF₂ | 1.38 | 0.292 | 26 |
| The 3rd layer | ZrO₂ | 2.07 | 0.515 | 31 |
| The 4th layer | MgF₂ | 1.38 | 2.323 | 210 |
| The 5th layer | ZrO₂ | 2.07 | 0.518 | 31 |
| The 6th layer | MgF₂ | 1.38 | 0.112 | 10 |
| The 7th layer | ZrO₂ | 2.07 | 1.357 | 82 |
| The 8th layer | MgF₂ | 1.38 | 1.018 | 92 |

TABLE 5
Fourth example
Structure of H4:
Reference wavelength λ0: 550 nm

| (1) | (2) | (3) | (4) | (5) |
|---|---|---|---|---|
| Substrate | BK7 | 1.52 | | |
| The 1st layer | Ta₂O₅ | 2.14 | 0.183 | 12 |
| The 2nd layer | SiO₂ | 1.46 | 0.425 | 40 |
| The 3rd layer | Ta₂O₅ | 2.14 | 0.643 | 41 |
| The 4th layer | SiO₂ | 1.46 | 0.279 | 26 |
| The 5th layer | Ta₂O₅ | 2.14 | 0.530 | 34 |
| The 6th layer | SiO₂ | 1.46 | 2.070 | 195 |
| The 7th layer | Ta₂O₅ | 2.14 | 0.635 | 41 |
| The 8th layer | SiO₂ | 1.46 | 0.159 | 15 |
| The 9th layer | Ta2O₅ | 2.14 | 0.808 | 52 |
| The 10th layer | MgF₂ | 1.38 | 0.961 | 96 |

TABLE 6
Fifth example
Structure of H5:
Reference wavelength λ0: 550 nm

| (1) | (2) | (3) | (4) | (5) |
|---|---|---|---|---|
| Substrate | LAH58 | 1.89 | | |
| The 1st layer | TiO₂ | 2.32 | 0.376 | 22 |
| The 2nd layer | MgF₂ | 1.38 | 0.149 | 15 |
| The 3rd layer | TiO₂ | 2.32 | 0.977 | 58 |
| The 4th layer | MgF₂ | 1.38 | 0.175 | 17 |
| The 5th layer | TiO₂ | 2.32 | 0.650 | 39 |
| The 6th layer | MgF₂ | 1.38 | 0.346 | 35 |
| The 7th layer | TiO₂ | 2.32 | 0.592 | 35 |
| The 8th layer | MgF₂ | 1.38 | 0.222 | 22 |
| The 9th layer | TiO₂ | 2.32 | 1.245 | 74 |
| The 10th layer | MgF₂ | 1.38 | 0.121 | 12 |
| The 11th layer | TiO₂ | 2.32 | 0.478 | 28 |
| The 12th layer | MgF₂ | 1.38 | 0.967 | 96 |

TABLE 7
Sixth example
Structure of H6:
Reference wavelength λ0: 550 nm

| (1) | (2) | (3) | (4) | (5) |
|---|---|---|---|---|
| Substrate | LAH58 | 1.89 | | |
| The 1st layer | ZrO₂ | 2.06 | 0.373 | 25 |
| The 2nd layer | Al₂O₃ | 1.65 | 0.216 | 18 |
| The 3rd layer | ZrO₂ | 2.06 | 0.732 | 49 |
| The 4th layer | Al₂O₃ | 1.65 | 0.209 | 18 |
| The 5th layer | ZrO₂ | 2.06 | 2.276 | 152 |
| The 6th layer | Al₂O₃ | 1.65 | 0.618 | 52 |
| The 7th layer | ZrO₂ | 2.06 | 0.189 | 13 |
| The 8th layer | Al₂O₃ | 1.65 | 0.927 | 77 |
| The 9th layer | ZrO₂ | 2.06 | 0.798 | 53 |
| The 10th layer | Al₂O₃ | 1.65 | 0.130 | 11 |
| The 11th layer | ZrO₂ | 2.06 | 0.812 | 54 |
| The 12th layer | MgF₂ | 1.38 | 0.962 | 96 |

TABLE 8
Seventh example
Structure of H7:
Reference wavelength λ0: 550 nm

| (1) | (2) | (3) | (4) | (5) |
|---|---|---|---|---|
| Substrate | LAH58 | 1.89 | | |
| The 1st layer | TiO₂ | 2.32 | 0.211 | 13 |
| The 2nd layer | SiO₂ | 1.46 | 0.168 | 16 |
| The 3rd layer | Ta₂O₅ | 2.14 | 1.646 | 106 |
| The 4th layer | Al₂O₃ | 1.67 | 0.160 | 13 |
| The 5th layer | TiO₂ | 2.32 | 0.318 | 19 |
| The 6th layer | Al₂O₃ | 1.67 | 0.720 | 60 |
| The 7th layer | TiO₂ | 2.32 | 0.213 | 13 |
| The 8th layer | Al₂O₃ | 1.67 | 0.627 | 52 |
| The 9th layer | Ta₂O₅ | 2.14 | 1.269 | 82 |
| The 10th layer | SiO₂ | 1.46 | 0.121 | 11 |
| The 11th layer | TiO₂ | 2.32 | 0.386 | 23 |
| The 12th layer | MgF₂ | 1.38 | 0.975 | 97 |

Next, a result of calculating an average value of reflectance characteristic of the anti-reflection film Ln (two types W1 and W2) and the anti-reflection film Lm (seven types H1 to H7) at the angle of incidence 0° is shown.

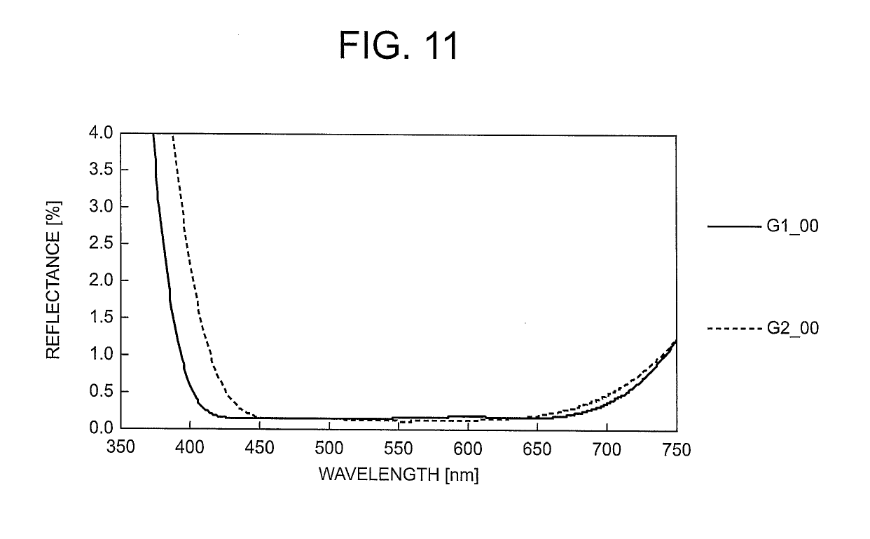

FIG. 11 is a diagram showing a result G1_00 and G2_00 of the following two average values at the angle of incidence z=0°.

G1_{—}00=(H1_{—}00+W1_{—}00)/2

G2_{—}00=(H2_{—}00+W2_{—}00)/2

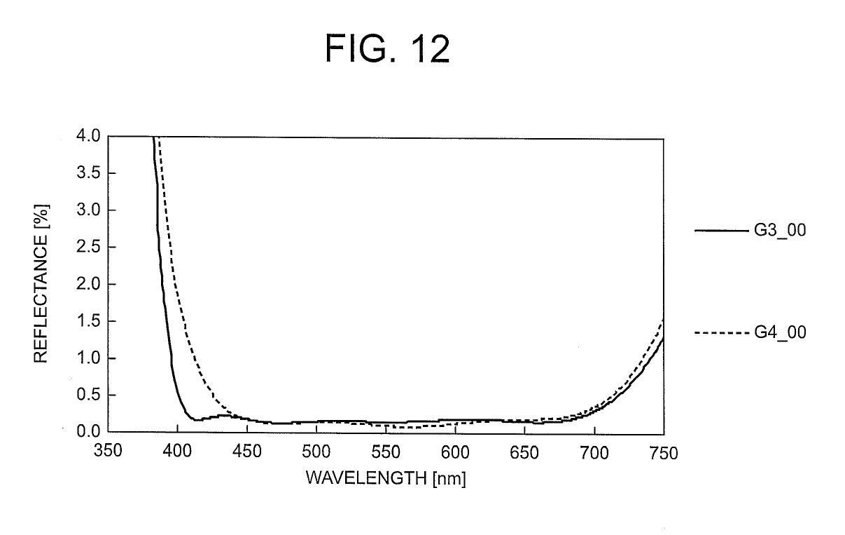

FIG. 12 is a diagram showing a result G3_00 and G4_00 of the following two average values at the angle of incidence z=0°.

G3_{—}00=(H3_{—}00+W1_{—}00)/2

G4_{—}00=(H4_{—}00+W2_{—}00)/2

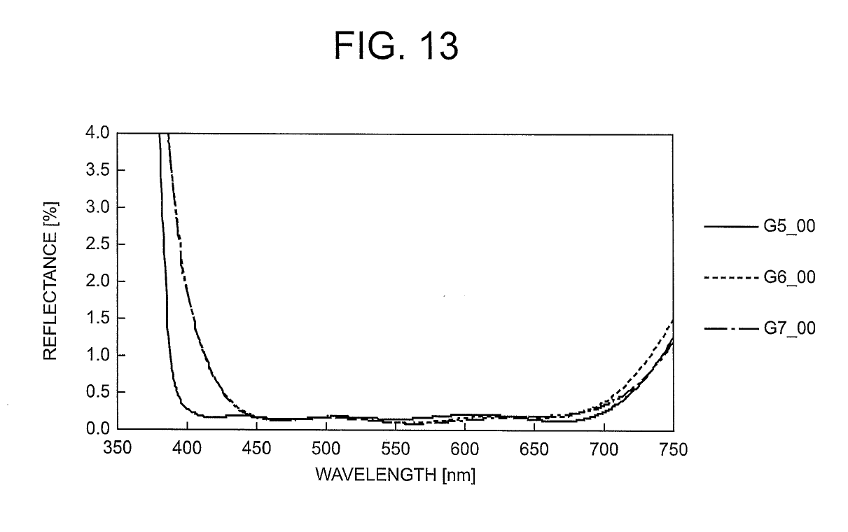

FIG. 13 is a diagram showing a result G5_00, G6_00, and G7_00 of the following three average values at the angle of incidence z=0°.

G5_{—}00=(H5_{—}00+W1_{—}00)/2

G6_{—}00=(H6_{—}00+W2_{—}00)/2

G7_{—}00=(H7_{—}00+W2_{—}00)/2

Conventional examples in which, the average value of reflectance characteristic is calculated for comparison and reference are shown below.

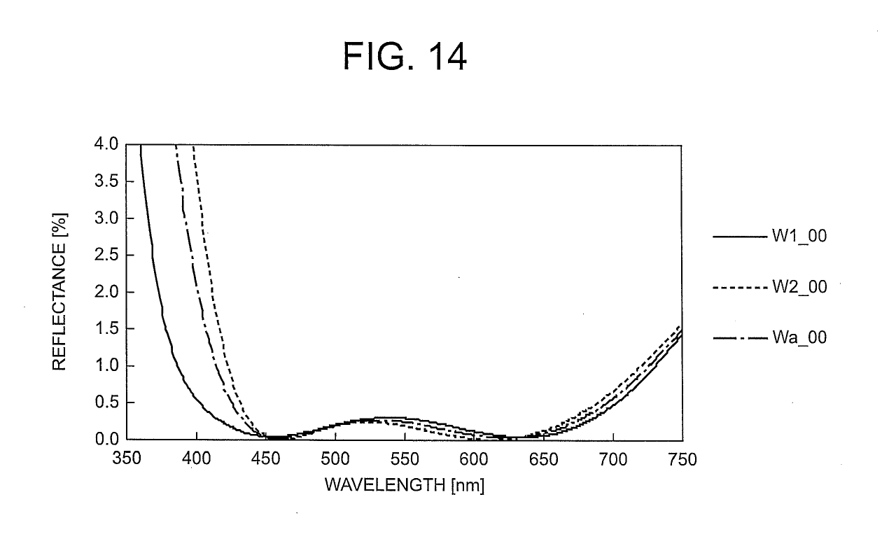

In FIG. 14, following three (types of) combinations in a case in which, two types of anti-reflection films having structures W1 and W2 respectively formed on the n^{th} optical surface are also formed on the m^{th} optical surface, at the angle of incidence z=0°, are calculated. Moreover, FIG. 14 shows W1_00, W2_00, and Wa_00 which is a result of adding the average values of respective reflectance characteristic.

As a first example for comparison

W1_{—}00=(W1_{—}00+W1_{—}00)/2

As a second example for comparison

W2_{—}00=(W2_{—}00+W2_{—}00)/2

As a third example for comparison

Wa_{—}00=(W1_{—}00+W2_{—}00)/2

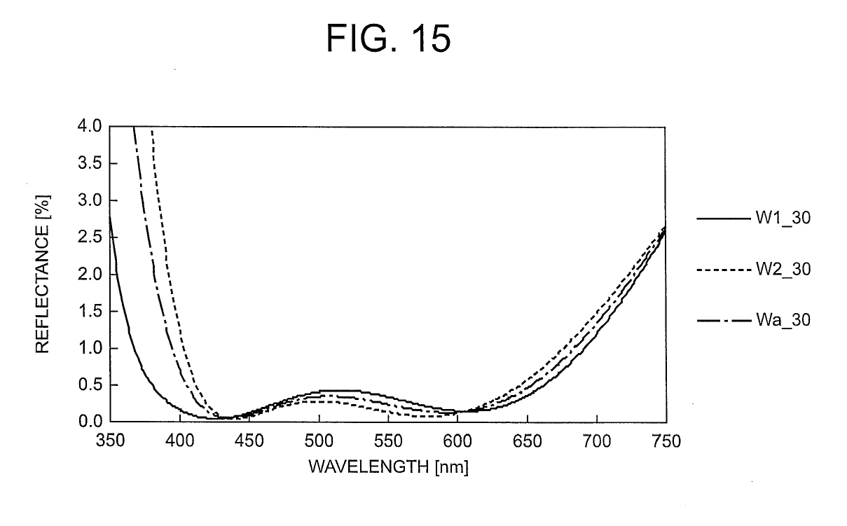

In FIG. 15, following three combinations in a case in which, two types of anti-reflection films having structures W1 and W2 respectively formed on the n^{th} optical surface are also formed on the m^{th} optical surface, at the angle of incidence z=30°, are calculated. Moreover, FIG. 15 shows W1_30, W2_30, and Wa_30 which is a result of adding the average value of respective reflectance characteristic.

As a first example for comparison

W1_{—}30=(W1_{—}30+W1_{—}30)/2

As a second example for comparison

W2_{—}30=(W2_{—}30+W2_{—}30)/2

As a third example for comparison

Wa_{—}30=(W1_{—}30+W2_{—}30)/2

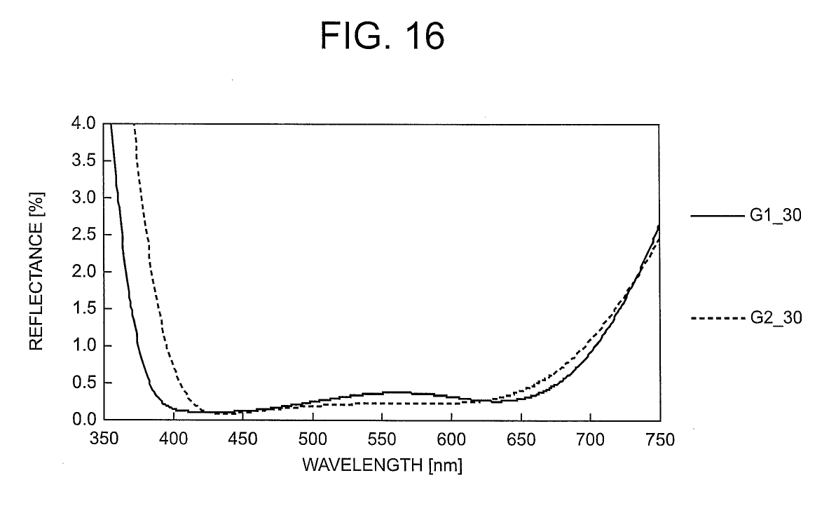

FIG. 16 is a diagram showing G1_30 and G2_30 which is a result of the following two average values at the angle of incidence z=30°.

G1_{—}30=(H1_{—}30+W1_{—}30)/2

G2_{—}30=(H2_{—}30+W2_{—}30)/2

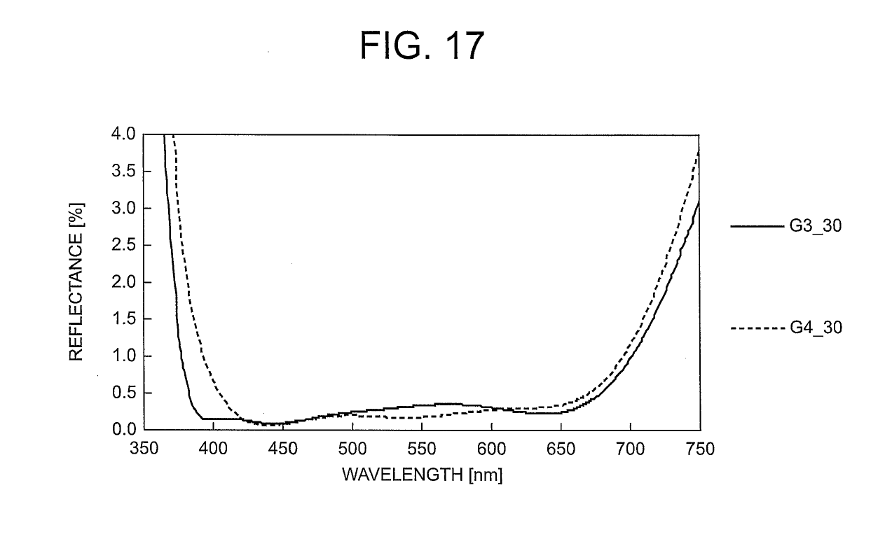

FIG. 17 is a diagram showing G3_30 and G4_30, which is a result of the following two average values at the angle of incidence z=30°.

G3_{—}30=(H3_{—}30+W1_{—}30)/2

G4_{—}30=(H4_{—}30+W2_{—}30)/2

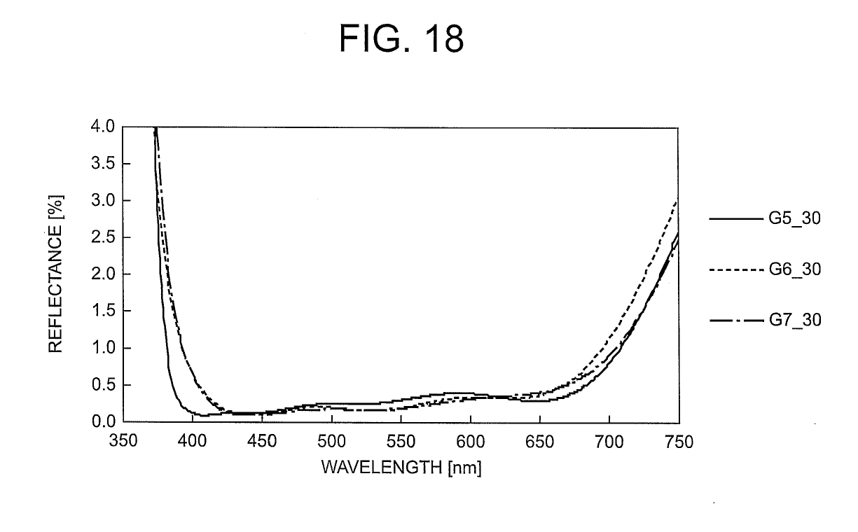

FIG. 18 is a diagram showing G5_30, G6_30, and G7_30, which is a result of the following three average values at the angle of incidence z=30°.

G5_{—}30=(H5_{—}30+W1_{—}30)/2

G6_{—}30=(H6_{—}30+W2_{—}30)/2

G7_{—}30=(H7_{—}30+W2_{—}30)/2

A difference between the maximum value and the minimum value of reflectance in a range of wavelength 450 nm ˜650 nm in diagrams from FIG. 11 to FIG. 18 is shown in table 9.

TABLE 9

| | reflectance difference | % |
|---|---|---|
| Angle of incidence | 0° | 30° |
| G1 | 0.03 | 0.25 |
| G2 | 0.08 | 0.30 |
| G3 | 0.06 | 0.26 |
| G4 | 0.11 | 0.26 |
| G5 | 0.07 | 0.27 |
| G6 | 0.10 | 0.27 |
| G7 | 0.10 | 0.30 |
| Comparison example1 | 0.27 | 0.31 |
| Comparison example2 | 0.24 | 0.51 |
| Comparison example3 | 0.25 | 1.29 |

As shown in table 9, when in a range 0°≦z≦30° of the angle of incidence z of a light ray with respect to the anti-reflection film, G(x) is let to be

G(x)=(Fm(x)+Fn(x))/2,

In the range of wavelength x=450 nm˜650 nm at the predetermined angle of incidence within the range, a reflectance difference f % between the maximum value and the minimum value of the function Fn(x) and a reflectance difference g % between the maximum value and the minimum value of the function G(x) at the predetermined angle of incidence, satisfy the following expression.

g≦f

Accordingly, the ghost image and flare are reduced.

In these examples, two types W1 and W2 are mentioned as the anti-reflection film Ln. Reflectance characteristic of W1 is as shown in FIG. 2 and reflectance characteristic of W2 is as shown in FIG. 3. Here, the abovementioned reflectance difference f is to be obtained from these diagrams.

Next, an anti-reflection band of the anti-reflection film Lm (seven types from H1 to H7) and the anti-reflection film. Ln (two types W1 and W2) at the angle of incidence 0° and 30° is shown in table 10. The ‘anti-reflection band’ means a value which is obtained by reading a width of the wavelength range in which the reflectance is 1% or less, and by rounding off the units. For instance, when the wavelength of an end of a short-wavelength side for which the reflectance is 1% is 400 nm and the wavelength of an end of a long-wavelength side is 700 nm, the anti-reflection band of the anti-reflection film is calculated to be ‘700 nm-400 nm’, which is 300 nm.

TABLE 10

| | anti-reflection band | nm |
|---|---|---|
| Angle of incidence | 0° | 30° |
| Example1: H1 | 350 | 340 |
| Example2: H2 | 360 | 330 |
| Example3: H3 | 350 | 330 |
| Example4: H4 | 350 | 330 |
| Example5: H5 | 360 | 340 |
| Example6: H6 | 350 | 330 |
| Example7: H7 | 370 | 340 |
| Comparison example1: W1 | 340 | 320 |
| Comparison example2: W2 | 300 | 270 |

As shown in table 10, when the anti-reflection band of the anti-reflection film Lm (seven types H1 to H7) for which the reflectance characteristic is Fm(X) is let to be Uz (unit: nm), and the anti-reflection band of the anti-reflection film Ln (two types W1 and W2) for which the reflectance characteristic is Fn(X) is let to be Vz (unit: nm), the anti-reflection band in the range 0°≦z≦30° of the angle of incidence z is Vz≦Uz.

Accordingly, in the wavelength range, the reflection of light is prevented, and the ghost image and flare are reduced.

A diagrammatic example in which, the anti-reflection band Uz when the angle of incidence is 0° is shown as the function Fm (X) of the reflectance characteristic in the diagram is shown in FIG. 6. Moreover, a diagrammatic example in which, the anti-reflection band Vz when the angle of incidence is 0° is shown as the function Fn(X) of the reflectance characteristic in the diagram, is shown in FIG. 2.

Diagrams of the other examples are also similar to FIG. 2 and FIG. 6. Here, a curve of the reflectance characteristic has W-shape, and when there is a band for which the reflectance crosses 1% partially, the bandwidth crossing that 1% is excluded from the anti-reflection band.

As it is shown in FIG. 4, FIG. 5, FIG. 6, FIG. 7, FIG. 8, FIG. 9, and FIG. 10, in a range of 45° and less of the angle of incidence z of a light ray on the anti-reflection film, in the wavelength range 450 nm˜650 nm, the reflectance is 2.0% and less.

Accordingly, in a wide range of the angle of incidence, the reflection of light is prevented, and the ghost image and flare are reduced.

Let a curve expressing the reflectance characteristic of the anti-reflection film formed on the m^{th} optical surface be the function Fm(x). The function Fm(x), as it is evident from FIG. 4, FIG. 5, FIG. 6, FIG. 7, FIG. 8, FIG. 9, and FIG. 10, has a waveform to negate at least one maximum value of the function Fn(x) of a curve expressing the reflectance characteristic of the anti-reflection film formed on the n^{th} optical surface shown in FIG. 2 and FIG. 3.

Moreover, the anti-reflection film Lm having reflectance characteristic shown by the function Fm(x) is formed on the optical surface on a side nearer to the light source 11, than the anti-reflection film Ln having reflectance characteristic shown by the function Fn(x).

Accordingly, it is possible to reduce light reflected from the n^{th} optical surface, at the m^{th} optical surface. Therefore, it is possible to reduce the ghost image and flare.

As it has been described above, the present invention is useful for an optical system having a lens and a prism for reducing the flare and ghost image.

The present invention shows an effect that it is possible to provide an optical element having an anti-reflection film with a favorable reflectance, which reduces the ghost image and flare.

What is claimed is:

1. An optical element having anti-reflection film, used in an optical system for guiding light generated from a light source, to an image forming surface, comprising:
an anti-reflection film having a reflectance characteristic expressed by a function Fm(x) (where, x denotes a wavelength), which is formed on an m^{th} optical surface when counted from a side of the light source; and
an anti-reflection film having a reflectance characteristic expressed by a function Fn(x) (where, x denotes a wavelength), which is formed on an n^{th} optical surface when counted from the side of the light source, wherein
at least one of the function Fm(x) and the function Fn(x) has the maximum value of reflectance in a predetermined wavelength, and has a characteristic curve of W-shape, and
the other of the function Fm(x) and the function Fn(x) has a wavelength that negates at least one maximum value of one of the function Fm(x) and the function Fn(x), and
the anti-reflection film having reflectance characteristic expressed by the function Fm(x) is formed on an optical surface on a side nearer to the light source, than the anti-reflection film having reflectance characteristic expressed by the function Fn(x),
where, m and n are positive integers, and m<n.

2. The optical element having anti-reflection film according to claim 1, wherein
when in a range 0°≦z≦30° of an angle of incidence z (unit degrees) of a light ray incident on the anti-reflection film, when G(x) is let to be G(x)=(Fm(x)+Fn(x))/2,
a reflectance difference f % between the maximum value and the minimum value of the function Fn (x) in a wavelength x=450 nm˜650 nm at a predetermined angle of incidence in the range, and
a reflectance difference g % between the maximum value and the minimum value of the function G (x) at the predetermined angle of incidence is g≦f.

3. The optical element having anti-reflection film according to claim 2, wherein
when in the range 0°≦z≦30° of the angle of incidence z of the light ray incident on the anti-reflection film, when
an anti-reflection band of the Fm(x) at a predetermined angle of incidence is let to be Uz (unit: nm), and
an anti-reflection band of the Fn (x) at a predetermined angle of incidence is let to be Vz (unit: nm),
then
Vz≦Uz.

4. The optical element having anti-reflection film according to claim 2, wherein
in a range 0°≦z≦45° of the angle of incidence z of the light ray incident on the anti-reflection film,
in a range of wavelength x=450 nm˜650 nm,
Fm(x)≦2.0%.

5. The optical element having anti-reflection film according to claim 3, wherein
in the range 0°≦z≦45° of the angle of incidence z of the light ray incident on the anti-reflection film,
in the range of wavelength x=450 nm˜650 nm,
Fm(x)≦2.0%.
